(19) United States
(12) Patent Application Publication
(10) Pub. No.: US 2018/0248405 A1
(43) Pub. Date: Aug. 30, 2018

(54) ELECTRIC POWER SUPPLY SYSTEM

(71) Applicant: ExH Corporation, Chiba (JP)

(72) Inventor: Kenichi HARAKAWA, Chiba (JP)

(21) Appl. No.: 15/737,168

(22) PCT Filed: Jun. 16, 2016
(86) PCT No.: PCT/JP2016/068004

§ 371 Date: Apr. 27, 2018

(30) Foreign Application Priority Data
Jun. 17, 2015 (JP) 2015-121963

(51) Int. Cl. H02J 50/05; H02J 50/40; H02J 50/80; H02J 50/70

(52) U.S. Cl. CPC H02J 50/05; H02J 50/70; H02J 50/80; H02J 50/40

(57) ABSTRACT

An electric power supply system includes an electric power transmission track that transmits electric power from an AC power source having a predetermined wavelength, an electric power reception unit, and a DC track that is used for transmitting DC electric power to the electric power transmission track. The electric power reception unit includes an electric power reception electrode, and moves along the electric power transmission track. The electric power reception unit forms junction capacitance by using the electric power transmission electrode and the electric power reception electrode, thereby receiving electric power from the electric power transmission track and supplies the received electric power to a load. The electric power transmission track includes a plurality of unit sections which are arranged repeatedly, and each of the plurality of unit sections has a length based on the predetermined wavelength and generates a standing wave from the AC power source.

### TECHNICAL FIELD

The present invention relates to an electric power supply system to which an electric field coupling electric power transmission technique is applied.

### BACKGROUND ART

The inventor of the present invention already invented an “electric field coupling system” as a new system of electric power transmission and invented a technique of a circuit capable of realizing the new system (hereinafter, referred to as an “electric field coupling electric power transmission technique) (see Patent Document 1). The electric field coupling electric power transmission technique is a technique that realizes contactless electric power electrical transmission by putting two metal plates (conductive plates) faced each other to form a capacitor by using these two metal plates as a pair of electrodes (such capacitor will be hereinafter referred to as a “junction capacitance”), thus and by conducting a high-frequency electric current.

The electric power electrical transmission system to which the electric field coupling electric power electrical transmission technique is applied includes an electric power transmission unit for transmitting the electric power from the electric power source, and an electric power reception unit for receiving the electric power from the electric power transmission unit and supplying the electric power to the load. In this case, junction capacitance is formed by arranging an electrode such as a metal plate provided at the downstream end of the electric power transmission unit (hereinafter referred to as a “electric power transmission electrode”) and an electrode such as a metal plate provided at the upstream end of the electric power reception unit (hereinafter referred to as a “electric power reception electrode”) to be faced each other.

The electric field coupling electric power transmission technique can be applied also to a slit coaxial track.

Patent Document 1: Japanese Unexamined Patent Application, Publication No. 2010-193692

### DISCLOSURE OF THE INVENTION

### Problems to be Solved by the Invention

FIG. 13 is a perspective view that illustrates an external configuration of a conventional slit coaxial track. The coaxial track 70 with a slit is an example of a conventional electric power transmission system to which an electric field coupling electric power transmission technique is applied. In the coaxial track 70 with a slit, a load (a camera or the like) driven using electric power is attached to be freely movable along the slit, and electric power can be transmitted to the load regardless of the position thereof (also during moving). The coaxial track 70 with a slit includes a connector 81, an outer conductor 82, and an inner conductor 83.

The connector 81 is a component having a load attached thereto and can freely move the load along the slit while supplying electric power to the load and includes an electric power reception electrode.

The outer conductor 82 is a conductive component having a rectangular parallelepiped shaped hollow and functions as a track extending in a rod shape in a predetermined direction, for example, like a curtain rail arranged on the wall of an office, a factory or the like. In other words, like a curtain rail, a predetermined face (which is not illustrated in FIG. 13 and hereinafter, this “predetermined face” will be referred to as a “rear face”) at the outside of the outer conductor 82 is connected to a wall or the like of an office or a factory. As illustrated in FIG. 13, a slit is formed on an external face (hereinafter, referred to as a “front face”) at the opposite side of the rear face. The connector 81 is attached to be able to move along this slit. In other words, in a state, a load not illustrated in the drawing is attached, the connector 81 freely moves along the slit of the outer conductor 82.

The inner conductor 83 is a rod-shaped conductor component that is arranged in a hollow part of the outer conductor 82 and extends in the same direction that is substantially the same as the longitudinal direction of the outer conductor 82.

Hereinafter, the outer conductor 82 and the inner conductor 83 will be collectively referred to as a “track” when it is appropriate. This track itself functions as an electric power transmission electrode. In other words, a portion of the track in which the connector 81 is positioned functions an electric power transmission electrode, and this electric power transmission electrode and the electric power reception electrode of the connector 81 forms a pair to make a junction capacitance.

In this case, when a contact state between the outer conductor 82 and the inner conductor 83 making the track is not good, reflection occurs inside a waveguide inside the track. The reflection occurring inside the waveguide can be an obstacle in manufacturing a slit coaxial track that does not degrade over time and at a low cost.

For this reason, it may be considered to use a coaxial track using aluminum, having no joint to apply an electric field coupling electric power transmission technique. However, in such a case, it is difficult to achieve transmission over a long distance.

The present invention is in consideration of such situations, and an object thereof is to establish a technique capable of long-distance transmission of electric power, allowing electric power to be taken out at an arbitrary position, performing communication in an electric power supply system to which an electric field coupling electric power transmission technique is applied.

### Means for Solving the Problems

An electric power supply system according to one aspect of the present invention is:

an electric power supply system to which an electric field coupling electric power transmission technique is applied, the electric power supply system including:

an electric power transmission track that transmits electric power from an AC power source having a predetermined wavelength;

an electric power reception unit that includes an electric power reception electrode, and moves along the electric power transmission track, wherein the electric power reception unit makes a portion of the electric power transmission track that faces the electric power reception electrode into an electric power transmission electrode, and forms junction capacitance by using the electric power transmission electrode and the electric power reception electrode, so that the electric power reception unit receives electric power from the electric power transmission track and supplies the received electric power to a load; and

a DC track that is used for transmitting DC electric power to the electric power transmission track,

wherein the electric power transmission track includes a plurality of unit sections which are arranged repeatedly,

wherein each of the plurality of unit sections has a length based on the predetermined wavelength and generates a standing wave from the AC power source,

wherein each of the plurality of the unit sections includes an inverter that converts DC electric power transmitted through the DC track into AC electric power having the predetermined wavelength.

The unit section may include one or more construction modules which are to be units for construction, and the construction module may include an inductor resonating with inter-line capacitance of the electric power transmission track.

The electric power supply system may include a transformer connected to the electric power reception electrode and having a primary side winding and a secondary side winding,

wherein the electric power reception unit may be configured to satisfy or substantially satisfy Z₀=n²R/m where an impedance of the track is denoted as Z₀;

a number of electric power reception units is denoted as m;

a resistance of the load is denoted as R; and

a ratio between a number of coil turns of the primary side winding and a number of coil turns of the secondary side winding is denoted as n:1.

Therefore, the transmission efficiency can be improved.

The electric power transmission track may have an unbalanced track structure including an outer conductor having a hollow portion and an inner conductor arranged in the hollow portion of the outer conductor,

wherein the outer conductor and the electric power reception electrodes forming the junction capacitance may be arranged to face each other at outside of the outer conductor, and

wherein the electric power supply system may further include a shield cover that covers the electric power reception electrodes.

The electric power transmission track may have an unbalanced track structure including an outer conductor having a hollow portion and an inner conductor arranged in the hollow portion of the outer conductor,

wherein the outer conductor and the electric power reception electrodes forming the junction capacitance may be arranged to face each other at inside of the outer conductor, and

wherein the electric power reception electrodes may be arranged to have symmetry to offset radiating electric fields.

The electric power supply system may further include: a communication track that is constituted by a leaky coaxial track and is used for communication.

It may be configured such that the communication track is covered with a metal shield being closed normally and having an opening end into which an antenna is inserted,

and the antenna that is used for transmitting/receiving electromagnetic waves from the communication track and can move in accordance with moving of the electric power reception unit is inserted into the end portion of the metal shield.

### Effects of the Invention

In the electric power supply system to which an electric field coupling electric power transmission technique is applied, it is possible to establish a technique capable of long-distance transmission of electric power, allowing electric power to be taken out at an arbitrary position, and performing communication.

### BRIEF DESCRIPTION OF THE DRAWINGS

FIG. 1 is a diagram that illustrates a basic circuit of an electric power transmission circuit to which an electric field coupling electric power transmission technique that is the basis of the present invention is applied.

FIG. 2 is a schematic view of an electric power supply track according to one embodiment of the present invention to which the electric power transmission circuit illustrated in FIG. 1 is applied.

FIG. 3 is a diagram that illustrates a track structure of a case where a DC electric power transmission line 24 and a communication track 25 are configured to run parallel in a contactless electric power transmission track 23 as an electric power supply track according to another embodiment of the present invention.

FIG. 4 is a diagram that illustrates a track structure of a case where a contactless electric power transmission track 23 and a DC electric power transmission line 24 are configured to be completely separated from each other and independently run parallel as an electric power supply track according to a further another embodiment of the present invention.

FIGS. 5A and 5B are diagrams that illustrate application examples of a unit section 51 and a construction module 52.

FIGS. 6A to 6D are diagrams that illustrate cross-sectional structures of a contactless electric power transmission track 23.

FIG. 7 is a diagram that illustrates the structure of a circuit of an electric power reception unit 2 and the contactless electric power transmission track 23 in an electric power supply track to which an electric field coupling electric power transmission technique that is the basis of the present invention is applied.

FIGS. 8A and 8B are diagrams that illustrate the cross-sectional structures of an electric power supply track to which the present invention is applied in the case where an electric power reception unit 2 is a mobile body.

FIGS. 9A and 9B are diagrams that illustrate examples of the arrangement of electric power reception electrodes 22 for an unbalanced track.

FIGS. 10A to 10I illustrate examples of the arrangement of electric power reception electrodes 22 in a balanced track.

FIGS. 11A to 11C are diagrams that illustrate measures for reducing attenuation of a communication signal in a communication track 25.

FIG. 12 is a diagram that illustrates a case where an outer conductor 32 and a DC electric power transmission line 24 are applied using a magnetic field coupling system.

FIG. 13 is a perspective view that illustrates the external configuration of a conventional coaxial line with a slit.

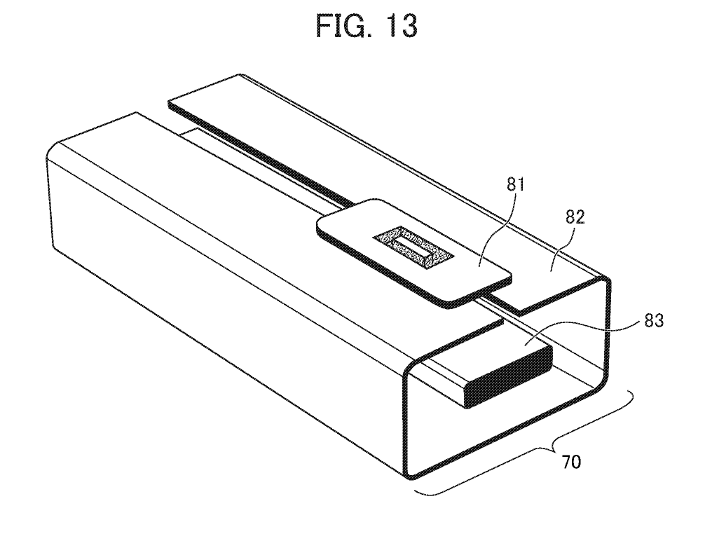

### PREFERRED MODE FOR CARRYING OUT THE INVENTION

Hereinafter, embodiments of the present invention will be described in detail.

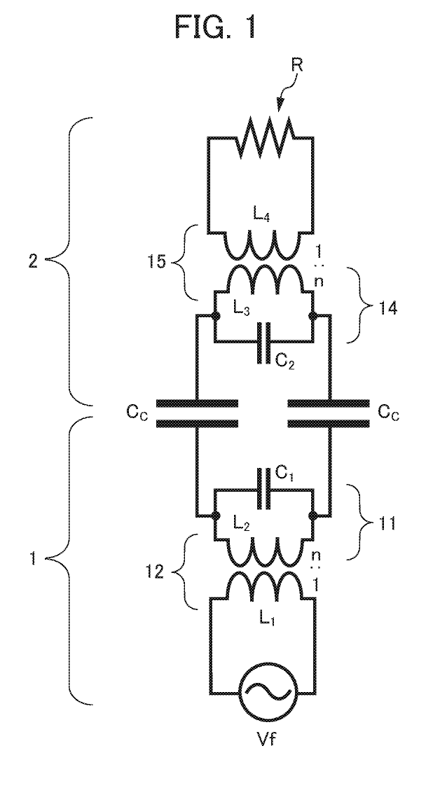

FIG. 1 is a diagram illustrating a basic circuit of the electric power transmission circuit to which the electric field coupling electric power transmission technique serving as a basis of the present invention is applied.

As shown in FIG. 1, the electric power transmission circuit to which the electric field coupling electric power transmission technique is applied includes an electric power transmission unit 1 and an electric power reception unit 2.

As described in the above “BACKGROUND ART”, the electric field coupling electric power transmission technique is a technique that realizes a contactless electric power electrical transmission by conducting a high-frequency electric current in a state forming a junction capacitance Cc using the pair of electrodes including two metal plates facing each other. More specifically, the electric field coupling electric power electrical transmission technique is realized by attaching the electric power transmission electrode of the metal plate to the end of the electric power transmission unit 1 for transmitting the electric power from an electric power source Vf, and by attaching the electric power reception electrode of the metal plate to the end of the electric power reception unit 2 receiving the electric power and supplying the electric power to a load R, and by arranging the electric power transmission electrode and the electric power reception electrode forming the pair of electrodes to face each other to form the junction capacitance Cc.

The electric power transmission unit 1 includes a parallel resonance circuit 11 and a transformer 12, and is connected to an alternating current electric power source Vf to receive the supply of the electric power. The parallel resonance circuit 11 is connected via the transformer 12 to the alternating current electric power source Vf, and includes a capacitor C1 and a coil L2. More specifically, the capacitor C1 and the coil L2 are connected in parallel to each other, whereby the parallel resonance circuit 11 is formed. Furthermore, the coil L2 is employed as the secondary side winding, and the coil L1 is employed as the primary side winding, whereby the transformer 12 is formed. In this case, since the number of windings of the coil L1: the number of windings of coil L2 is set as 1:n, the voltage at the primary side, i.e. the voltage of the alternate current electric power source Vf, is stepped up n times by the transformer 12, and then is applied to the parallel resonance circuit 11. Two electric power transmission electrodes are connected to both ends of the parallel resonance circuit.

The electric power reception unit 2 includes a parallel resonance circuit 14 and a transformer 15. The parallel resonance circuit 14 is connected to two electric power reception electrodes of the electric power reception unit 2, and includes a capacitor C2 and a coil L3. More specifically, the capacitor C2 and the coil L3 are connected in parallel to each other, whereby the parallel resonance circuit 14 is formed. Furthermore, the coil L3 is employed as the primary side winding, and the coil L4 is employed as the secondary side winding, whereby the transformer 15 is formed. In this case, since the number of windings of the coil L3: the number of windings of the coil L4 is set as n:1, the voltage at the primary side, i.e. the voltage received by the electric power reception electrode and applied to the parallel resonance circuit 14, is stepped down 1/n times by the transformer 15, and then is applied to the load R.

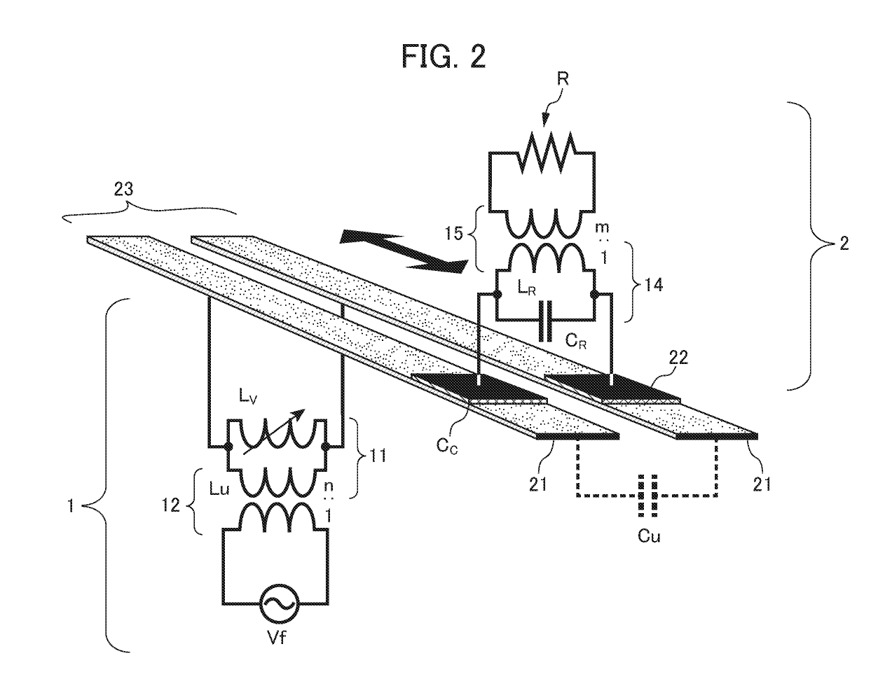

FIG. 2 is a schematic diagram illustrating one embodiment of an electric power supply track to which the present invention is applied and in which the electric power transmission circuit of FIG. 1 is applied.

As shown in FIG. 2, the electric power transmission unit 1 causes each of the two tracks extending in a rod shape in a predetermined direction to function as the electric power transmission electrode 21. It should be noted that these electric power transmission electrodes 21 that are the two tracks will be collectively referred to as a “contactless electric power transmission track 23”. More specifically, the electric power reception unit 2 being the mobile body is configured to be freely movable along the contactless electric power transmission track 23 by arranging each of the two electric power reception electrodes 22 so as to be opposed to the contactless electric power transmission electric track 23. Two junction capacitances Cc (junction capacitances Cc at the left-hand side and the right-hand side of FIG. 1) are respectively formed by the two electric power reception electrodes 22 and the two electric power transmission electrodes 21 constituting the contactless electric power transmission track 23. More specifically, the electric power reception unit 2 can freely move on the contactless electric power transmission track 23, and can receive the electric power from any position on the contactless electric power transmission track 23.

However, as shown in FIG. 2, in the case of the electric power transmission electrodes 21 being configured as tracks in a long rod shape, a line capacitance Cu cannot be disregarded. Therefore, let a resonance occur between the line capacitance Cu and the electric power transmission-side inductor Lu (corresponding to the coil L2 of FIG. 1). Therefore, the transmission efficiency of the electric power can be improved. It should be noted that, in addition to the electric power transmission-side inductor Lu, an electric power transmission-side inductor Lv for adjustment may be inserted as shown in FIG. 2 (in this case, a parallel circuit of the electric power transmission-side inductor Lu and the electric power transmission-side inductor Lv for adjustment corresponds to the coil L2 in FIG. 1). Furthermore, although the electric power transmission-side inductor Lv for adjustment is connected in parallel in the example of FIG. 2, the electric power transmission-side inductor Lv for adjustment may be connected in series.

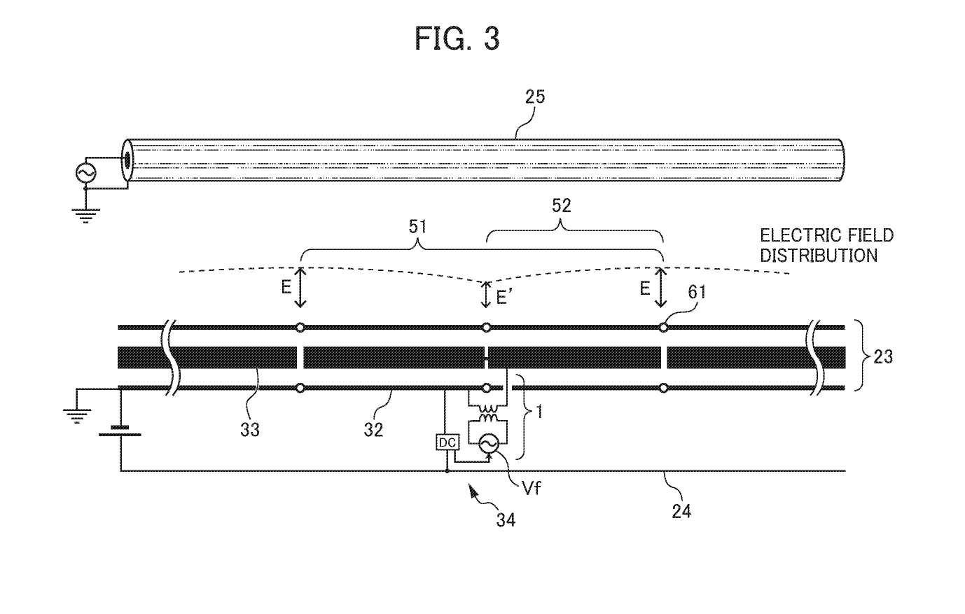

FIG. 3 is a diagram that illustrates a track structure of a case where a DC electric power transmission line 24 and a communication track 25 are configured to run parallel with contactless electric power transmission track 23 as another embodiment of the electric power supply track to which the present invention is applied.

The contactless electric power transmission track 23 of the example illustrated in FIG. 3 includes an outer conductor 32 and an inner conductor 33.

The DC electric power transmission line 24 runs parallel with the contactless electric power transmission track 23. In other words, in order to cause an electric power supply track to which the present invention is applied to employ to long-distance electric power transmission in the order of km, a problem of long distance transmission of electric power and a problem of a standing wave need to be solved. In this embodiment, in order to solve the problem of the long distance transmission of electric power, DC electric power transmission using the DC electric power transmission line 24 is employed. In other words, since a current flows through the full cross section of the electric power transmission line (in this example, the DC electric power transmission line 24), the use efficiency of the material in DC electric power transmission is higher than that of AC electric power transmission. In addition, a voltage in the case of DC electric power transmission can be a voltage that is 0.707 times that of a case where the same electric power is flown using AC. Furthermore, a link with a super-conductive current electric power transmission system can be easily made. Therefore as an electric power transmission unit, the DC electric power transmission line 24 is employed.

For contactless electric power supply to which electric field coupling electric power transmission technique is applied, an AC electric power source Vf used for causing a high-frequency current having the frequency band of about 100 kHz to 10 MHz to flow is necessary. Thus, in this embodiment, one inverter 34 converting a DC flowing though the DC electric power transmission line 24 into an AC is disposed for each unit section 51 of the contactless electric power transmission track 23. The reason for dividing the contactless electric power transmission track 23 into a plurality of unit sections 51 will be described later.

Here, the inverter 34 of each unit section 51 is not constantly driven, but only the inverter 34 of the unit section 51 that is necessary in accordance with the presence position of the electric power reception unit 2 that is a mobile body is driven. DC electric power transmitted from the DC electric power transmission line 24 is converted into AC electric power by the inverter 34 being driven. The AC electric power converted by this inverter 34 is supplied from the AC electric power source Vf of the electric power transmission unit 1 to the electric power reception electrode, in other words, the outer conductor 32 and the inner conductor 33 through the electric power transmission unit 1 and is further supplied to the electric power reception unit 2 in a contactless manner. The outer conductor 32 is connected to the DC electric power transmission line 24 and the electric power transmission unit 1, thereby functioning as a part of a DC track and reducing radiation of electromagnetic waves accompanying the electric power transmission.

Here, in contactless electric power supply, when the AC power source Vf is used, the transmitted high frequency wave is reflected on the end portion and is returned, and accordingly, a standing wave is generated. When the standing wave is generated, an antinode and a node of a voltage alternately appear, and, in the case of a high frequency track, a node of an electric field (an antinode of a current), and a node of a current (an antinode of the electric field) alternately appear.

At this time, in the case of contactless electric power supply to which the electric field coupling electric power transmission technique is applied, electric power cannot be received at the node of an electric field (an antinode of a current). Even in the case of the receiving point not being a node of an electric field (an antinode of a current), when it is close to a node of an electric field (an antinode of a current), the electric power reception performance is degraded. Here, as a contactless electric power supply technique other than the electric field coupling electric power transmission technique, there is a magnetic field coupling system. In the case of the magnetic field coupling system, contrary to the case of the electric field coupling electric power transmission technique, electric power cannot be received at a node of a current (an antinode of an electric field). In addition, even in the case of the receiving point not being a node of a current (an antinode of an electric field), when it is close to a node of the current (an antinode of an electric field), the electric power reception performance is degraded.

As one method for preventing this, there is a method in which power reception means of both electric field coupling system (electric field coupling electric power transmission technique) and magnetic field coupling system are included in the electric power reception unit 2, and the electric power reception means is selectively used in accordance with the positions of antinodes and nodes of an electric field and a current. More specifically, in the method, electric power is received at a node of an electric field (an antinode of a current) by using the magnetic field coupling system, and at a node of a current (an antinode of an electric field) by electric power is received using the electric field coupling electric power transmission technique.

However, in the case of the method in which the power reception means of the electric field coupling system and the magnetic field coupling system are appropriately selectively used, the electric power reception unit 2 physically includes two systems, and accordingly, there are problems in that the electric power reception unit 2 increases in size and cost.

In addition, in the case of contactless electric power supply using the magnetic field coupling system, it is necessary to use a ferrite core for the purpose of absorption of high frequency noises, there is a problem in that the weight increases by the amount corresponding to the ferrite core. Furthermore, since it is necessary to cause a current to flow for supplying electric power that is necessary for appropriately using the power reception means of the electric field coupling system and the magnetic field coupling system, there is a problem in that a copper loss (a loss generated in accordance with winding resistance components in an inductor and a coil) increases in accordance with an increase of the distance.

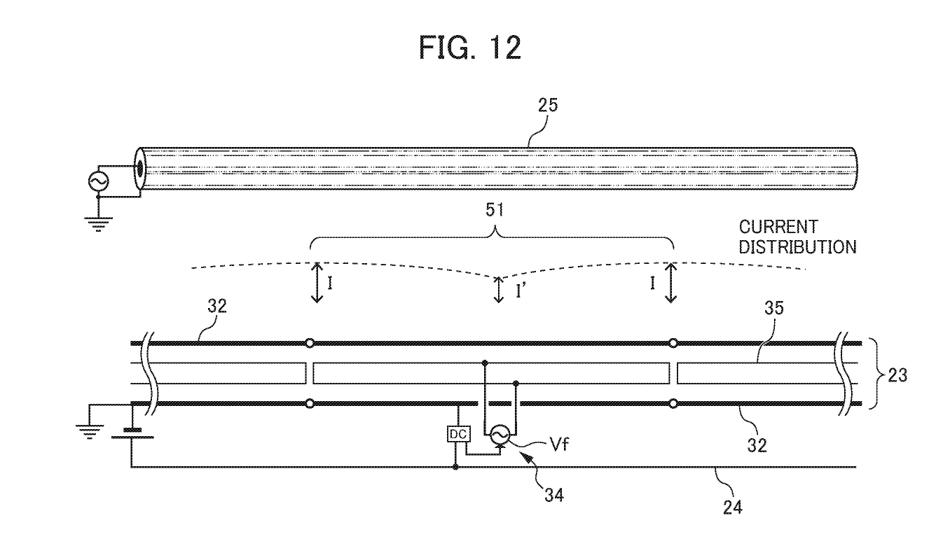

In order not to cause such various problems or in order to solve the problems, in this embodiment, only the electric field coupling system (electric field coupling electric power transmission technique) is employed, and a unit section 51 having a length based on the wavelength of a transmission frequency is disposed, and a standing wave is generated only within the unit section 51. As in this embodiment, in the case of the electric field coupling system, by causing the end portion of the transmission track (in the example illustrated in FIG. 3, the contactless electric power transmission track 23) to be open, the electric field can have a maximum value in the end portion. In addition, by setting the length of the unit section 51 to be small, arranging an inverter 34 at the center of the unit section 51, and performing reflection on both ends of the unit section 51, voltage variations can be suppressed to be low. In addition, the technical idea of the unit section 51 can be applied not only to the electric field coupling system but also, as will be described later with reference to FIG. 12, to a magnetic field coupling system. However, in a case where the technical idea is applied to the magnetic field coupling system, the end portion needs to be shorted.

For example, a wavelength (λ) of the transmission using 6.78 MHz is 44.2 m, and an antinode or a node appears every 22.1 m that is 1/2 of the wavelength (λ/2). For this reason, when a distance from the inverter 34 to the end portion is λ/12, variations in the voltage can be suppressed in ±5%. In addition, in a case where end portions of λ/12 are disposed on both sides of the inverter 34, the unit section 51 is λ/6 (=7.4 m), and the voltage value is substantially constant. For example, the wavelength (λ) of a case where transmission is performed using 2 MHz is 150 m, and λ/6 is 25 m.

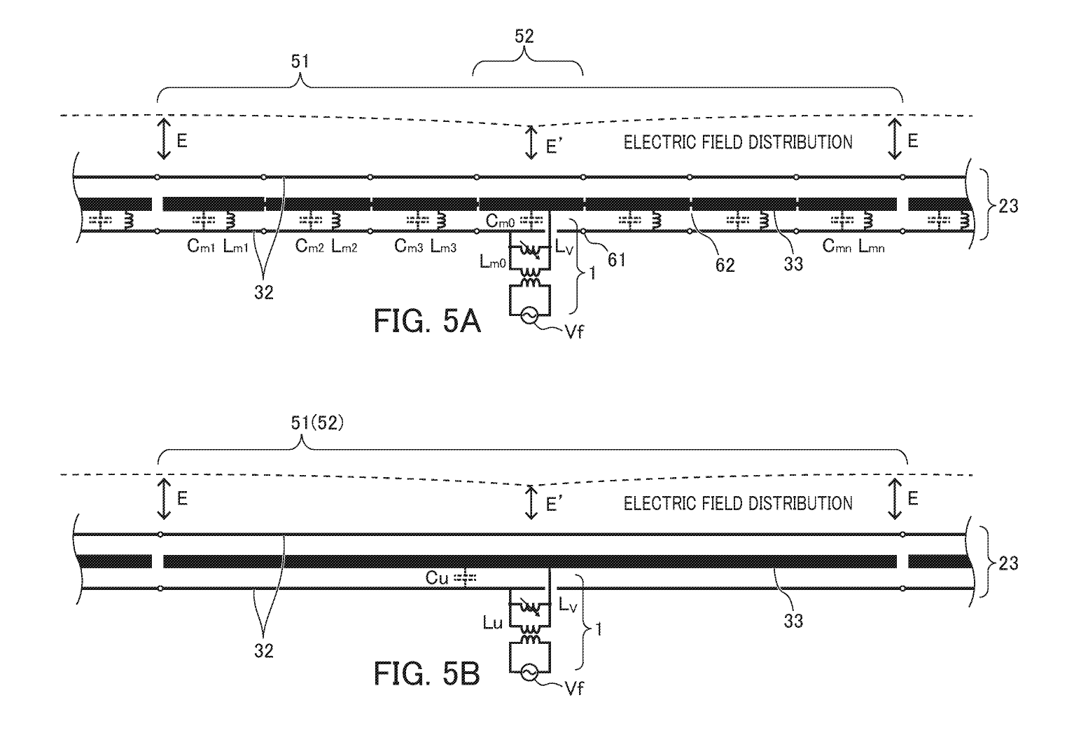

By repeatedly connecting the unit section 51 having a length (for example, a length of λ/6) that is based on the wavelength λ of the transmission frequency and placing the inverter 34 receiving electric power from the DC electric power transmission line 24 at the center thereof, a voltage section that is substantially constant can be realized in the whole section. A specific example of this point will be described later with reference to FIGS. 5A and 5B.

Next, the communication track 25 will be described.

The communication track 25 runs parallel to and is independent from the contactless electric power transmission track 23. In addition, the communication track 25 runs parallel to and is independent from the contactless electric power transmission track 23, and signals are transmitted from a communication transceiver. In addition, the communication transceiver and a communication relay amplifier (not illustrated) in the communication track 25 are connected to the DC electric power transmission line 24 and receive the supply of electric power.

In the case where the communication track 25 and the contactless electric power transmission track 23 are configured as an integration type, there is a problem in the processing accuracy of an outer conductor connecting part 61 accompanying with long distance laying. In other words, when the connection state of the outer conductor deteriorates in accordance with a change in the outer conductor connecting part 61 with time, there is concern that an obstacle such as reflection of a communication wave or the like may appear. In addition, in order to prevent this, in a case where the processing accuracy of the outer conductor connecting part 61 is to be improved, it leads to an increase in the cost.

A communication signal is transmitted through the communication track 25. Accordingly, it is sufficient to cause DC electric power or contactless electric power (AC power of a high frequency) to flow through the contactless electric power transmission track 23, and a communication track communication signal does not need to flow therethrough. In this way, a requested value for the processing accuracy is decreased, and implementation of a low cost can be achieved. The frequency band of a communication signal of this case is a frequency band of GHz.

The communication track 25 preferably can be laid for a long distance at once. For example, as the communication track 25, a leaky coaxial cable (LCX) may be employed. In the communication track 25 illustrated in FIG. 3 or FIGS. 4 and 12 to be described later, the LCX is employed. The reason for employing LCX is that it has advantages that the quality can be maintained to be constant due to high mass productivity, and an existing product can be used to decrease the cost.

In addition, by configuring an antenna to run parallel in a contactless manner, the LCX may be also used in the electric power reception unit 2 (mobile body) side.

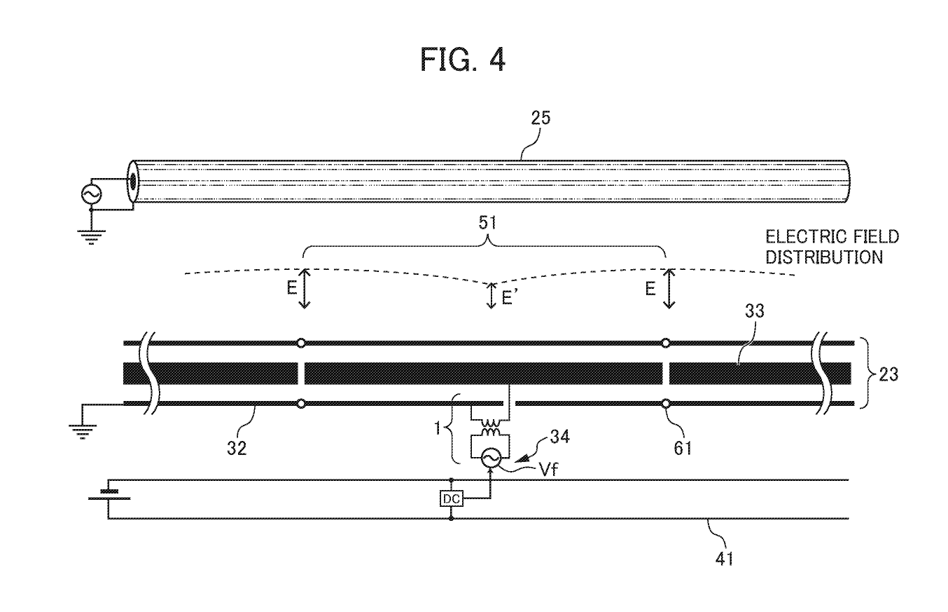

FIG. 4 is a diagram that illustrates a track structure of a case where a contactless electric power transmission track 23 and a DC electric power transmission line 24 are configured to be completely separated from each other and independently run parallel as an electric power supply track being a further another embodiment of the present invention.

The contactless electric power transmission track 23 of the example illustrated in FIG. 4 includes an outer conductor 32 and an inner conductor 33. To the contactless electric power transmission track 23, a DC electric power transmission line 41 independently runs parallel. In addition, each outer conductor 32 is connected to an outer conductor connecting part 61 for each unit section 51. An AC power source Vf of an electric power transmission unit 1, similar to the example illustrated in FIG. 3, is a power source, to which the electric field coupling electric power transmission technique is applied, for supplying electric power in a contactless manner.

In addition, the electric power supply track of the example illustrated in FIG. 4, similar to the example illustrated in FIG. 3, a communication track 25 runs parallel and is independent from the contactless electric power transmission track 23 and is connected to an AC power source. In this case, similar to the example illustrated in FIG. 3, the implementation of the processing accuracy for the communication track 25 and the contactless electric power transmission track 23 can be achieved at a low cost; however, the outer conductor 32 does not function as a part of the DC electric power transmission line 41 but is in an independent form, and thus the material cost is higher than that of the electric power supply track of the example illustrated in FIG. 3.

Next, the unit section 51 will be described again with reference to FIGS. 5A and 5B.

FIGS. 5A and 5B are diagrams that illustrate application examples of the unit section 51 and the construction module 52. FIG. 5A illustrates a case where the unit section 51 is configured by combining a plurality of short construction modules 52.

As described above, the unit section 51 represents a section that is set to have a length for which a voltage variation is small on the basis of the wavelength λ of the electric power transmission frequency and is a unit for generating a standing wave. The construction module 52 represents a functional unit that can be replaced in construction. In other words, the unit section 51 is configured by one or more construction modules 52.

As illustrated in FIG. 5A, in a case where the unit section 51 is configured by the plurality of construction modules 52, each of the construction modules 52 is connected to the outer conductor 32 by using the outer conductor connecting part 61. On the other hand, basically, each of the construction modules 52 is connected to the inner conductor 33 by using an inner conductor connecting part 62. Here, the construction module 52 that is an end portion of the unit section 51 is open. In other words, connection between the inner conductors 33 is not performed on the boundary of the unit sections 51. In this way, a high frequency wave used for contactless electric power supply can be reflected, and accordingly, a standing wave can be generated only within the unit section 51. In a case where the configuration illustrated in FIG. 5A, for the bonding between the construction modules 52, together with the outer conductor 32 and the inner conductor 33 are mechanically and electrically connected.

In this case, as to a resonant inductor attached to the electric power transmission unit 1, in the case where the unit section 51 is configured by n (here, n is an integer value) construction modules 52, an inductor Lmk resonating at an electric power transmission frequency with capacitance Cmk (here, k is an integer value of 1 to n) between the inner conductor 33 and the outer conductor 32 of the construction modules 52 is attached to each of the n construction modules 52. At this time, the lengths of the construction modules 52 do not need to be uniform. In addition, an inductor Lm0 for resonance (matching) is attached to the outside of the electric power transmission unit 1, and electric power can be supplied from the inductor.

FIG. 5B illustrates a case where the unit section 51 and the construction module 52 are the same, in other words, a case where the unit section 51 is configured by one construction module 52. In this case, only the outer conductors 32 are connected between the construction modules (the unit sections 51) adjacent to each other. In other words, for the bonding between the construction modules 52, the outer conductors 32 are mechanically and electrically connected. In the case where the configuration illustrated in FIG. 5B is employed, for example, when the unit section 51 is 7 m, the unit section track can be generated in a factory and delivered in a long body track, and bonding, fixing, wiring, and the like can be easily performed at a construction place such as a tunnel.

In a case where the configuration illustrated in FIG. 5B is employed, a transformer 12 and an inverter 34 for matching can be attached and adjusted in a factory and then shipped. In addition, fine adjustment can be performed using an electric power transmission side inductor Lv illustrated in the schematic diagram illustrated in FIG. 2.

In this way, by repeatedly connecting the unit sections 51 each configured by one or more construction modules 52 as illustrated in FIGS. 5A and 5B and by placing the inverter 34 receiving electric power from the DC electric power transmission line 24 at the center thereof, a section having a substantially constant voltage can be realized in the whole section.

In addition, the AC power source Vf receives electric power of a lowest limit, detects a signal from the electric power reception unit 2, a server(not illustrated), an AC power source adjacent thereto, or the like, and wakes up when the electric power reception unit 2 approaches. In addition, when the AC electric power source Vf operates together with the adjacent AC power source Vf, the AC electric power source takes synchronization and transmits a signal.

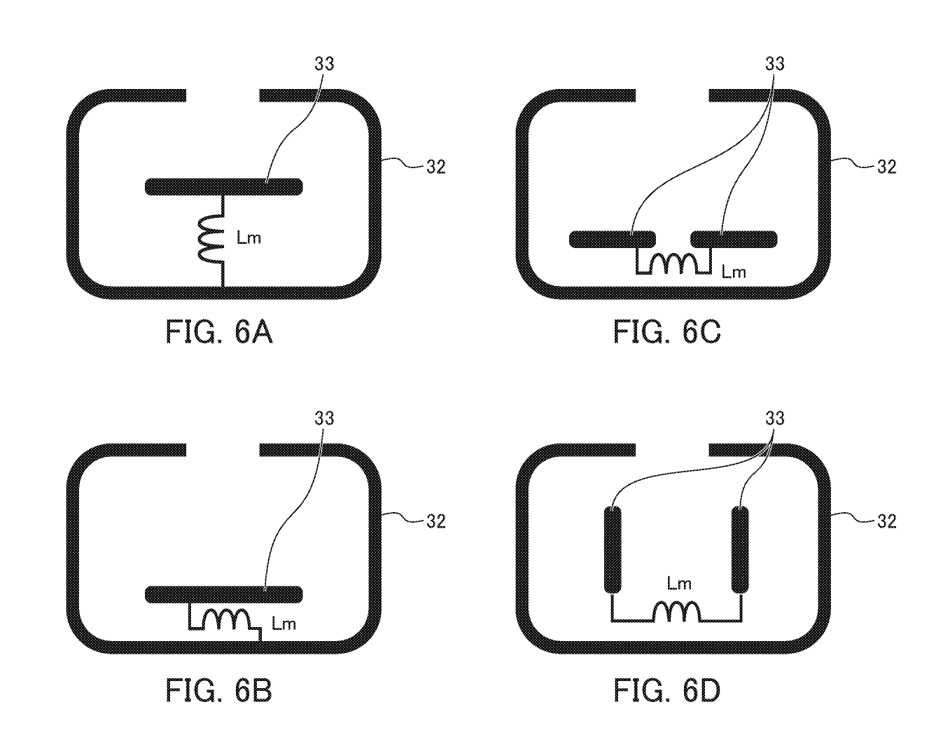

Next, the structure of the contactless electric power transmission track 23 will be described. FIGS. 6A to 6D are diagrams that illustrate cross-sectional structures of a contactless electric power transmission track 23. FIGS. 6A and 6B are diagrams that illustrate the structures of the contactless electric power transmission track 23 having an unbalanced track structure. FIGS. 6C and 6D are diagrams that illustrate the structures of the contactless electric power transmission track 23 having a balanced track structure.

As illustrated in FIGS. 6A and 6B, the contactless electric power transmission track 23 having the unbalanced track structure is configured by an outer conductor 32 that functions as an electric power transmission electrode and one inner conductor 33, which is arranged inside the outer conductor 32, and functions as an electric power transmission electrode. The outer conductor 32 and the inner conductor 33 are connected using a resonant inductor Lm. In addition, the resonant inductor Lm may be put outside the outer conductor 32.

As illustrated in FIGS. 6C and 6D, the contactless electric power transmission track 23 having a balanced track structure is configured by an outer conductor 32 and two inner conductors 33 arranged inside the outer conductor 32. Each of the two inner conductors 33 functions as two electric power transmission electrodes and is connected to a resonant inductor Lm. In other words, the outer conductor 32 in the contactless electric power transmission track 23 having the balanced track structure is used for shielding from electron radiation from the contactless electric power transmission track 23, but not contribite to electric power transmission (not functioning as an electric power transmission electrode), fixing the track, a rail of a running vehicle, and the like. In addition, the resonance inductor Lm may be put outside the outer conductor 32.

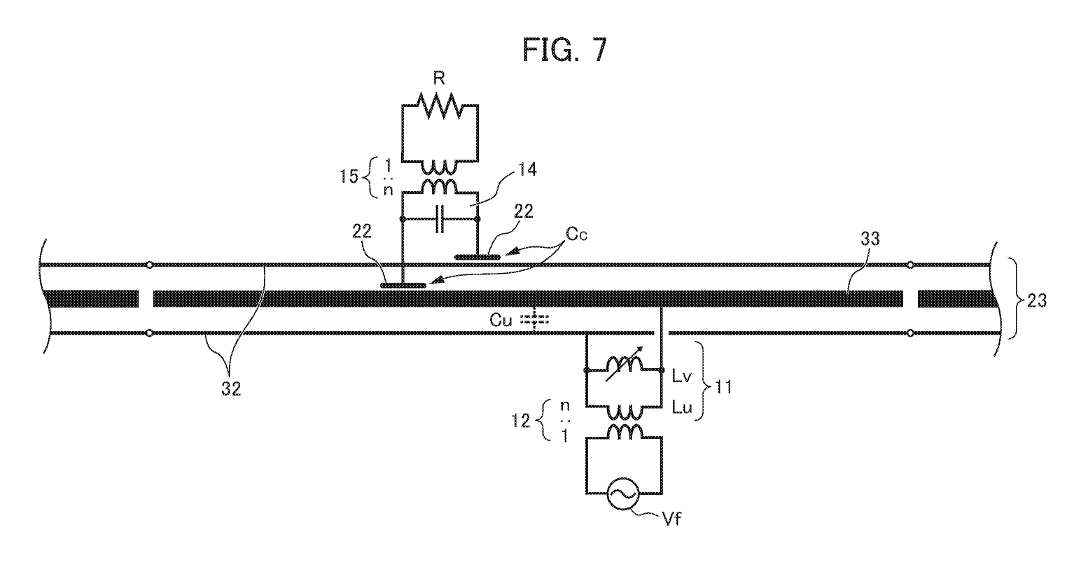

Next, the electric power reception unit 2 will be described. FIG. 7 is a diagram that illustrates the structure of a circuit of an electric power reception unit 2 and the contactless electric power transmission track 23 in an electric power supply track to which an electric field coupling electric power transmission technique that is the basis of the present invention is applied.

A parallel resonant circuit 14 included in the electric power reception unit 2 illustrated in FIG. 7 is equivalent to a state in which a resistor of n²R is connected in parallel with a resonant inductor. For this reason, by increasing n²R, the Q value of the parallel resonant circuit 14 can be increased.

By increasing the Q value of the parallel resonant circuit 14, the input impedance of the electric power reception unit 2 becomes n²R to be sufficiently larger than the impedance Z₀ of the track, whereby a plurality of the electric power reception units 2 can simultaneously run on a track of the same unit section 51.

When the voltage distribution on the track is substantially constant, the impedance of the track is Z₀, and the number of electric power reception units 2 is m, maximum electric power reception efficiency can be acquired when Z₀=n²R/m.

The electric power reception units 2 move, and the number thereof increases or decreases between tracks adjacent to each other, and thus the relation described above cannot be necessarily maintained. However, by approximating Z₀ and n²R/m, high transmission efficiency can be maintained.

When the number of electric power reception units 2 is known and can be delivered to each of the electric power reception units 2, by changing n or R, the relation described above can be maintained.

By taking such a measure, a plurality of electric power reception units 2 can simultaneously run on the track of the same unit section 51.

In addition, the size of the electric power reception electrodes of each of the electric power reception units 2 is assumed to be sufficiently larger than the size of a gap on the boundary of the unit section 51 in the inner conductor 33. In this way, although the junction capacitance Cc at the time of passing the gap is slightly decreased, the gap passing can be performed without any problem.

In addition, by mounting a battery in the electric power reception unit 2, the passing can be performed without any problem even when there is an electric power reception section in a bad condition. In addition, the electric power reception unit 2 can acquire the position itself by reading a linear marker attached to the track.

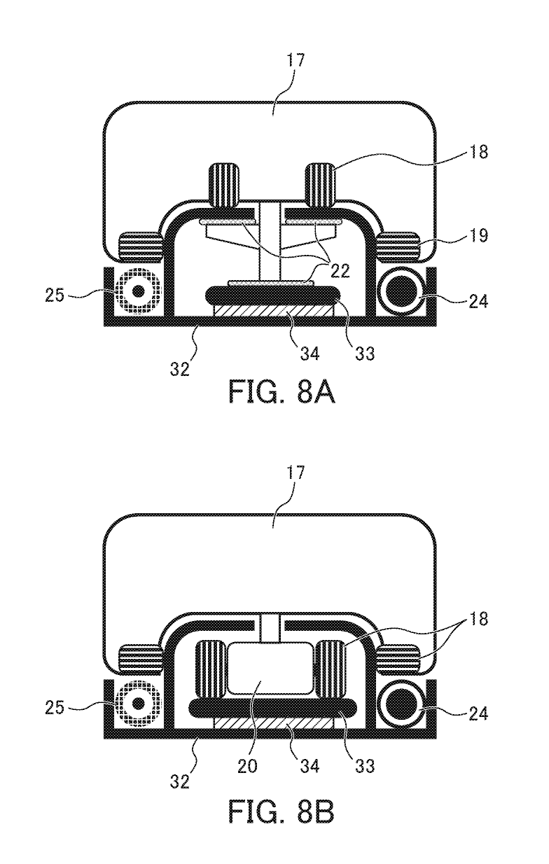

FIGS. 8A and 8B are diagrams that illustrate the cross-sectional structures of an electric power supply track to which the present invention is applied in a case where the electric power reception unit 2 is a mobile body.

In the example illustrated in FIGS. 8A and 8B, a DC electric power transmission line 24 and a communication track 25 run in parallel at the outside of the outer conductor 32. For example, the DC electric power transmission line 24 and the communication track 25 have structures in which after connecting aluminum blocks of the unit section 51, attachment is performed afterwards in accordance with the construction of a current site and are fixed to an outer conductor 32 by using a calking compound or the like. The outer conductor 32 and an inner conductor 33 are delimited by an insulated layer 34.

FIG. 8A illustrates an example in which a driving wheel 18 included in a moving/communicating/acting unit 17 (corresponding to the electric power reception unit 2 illustrated in FIG. 1) is arranged to run on the upper face of the outer conductor 32. The moving/communicating/acting unit 17 in the example illustrated in FIG. 8A includes the driving wheel 18 for moving on the contactless electric power transmission track 23 and the guide wheel 19 used for preventing rolling at the time of moving. In addition, an electric power reception electrode 22 is included on the face facing each of the outer conductor 32 and the inner conductor 33, and the supply of electric power is received from an electric power transmission unit 1 through the outer conductor 32 and the inner conductor 33.

FIG. 8B illustrates an example in which the driving wheel 18 included in the moving/communicating/acting unit 17 (corresponding to the electric power reception unit 2 illustrated in FIG. 1) is arranged to run on the upper face of the inner conductor 33 and the side face of the outer conductor.

A moving electric power reception unit 20 (corresponding to the electric power reception unit 2 illustrated in FIG. 1) in the example illustrated in FIG. 8B is arranged to be sandwiched by the driving wheel running on the upper face of the inner conductor 33 and approaches the inner conductor 33. In addition, an electric power reception electrode 22 is included, and the supply of electric power is received from the electric power transmission unit 1 through the inner conductor 33.

The examples illustrated in FIGS. 8A and 8B can be selectively used in accordance with the use.

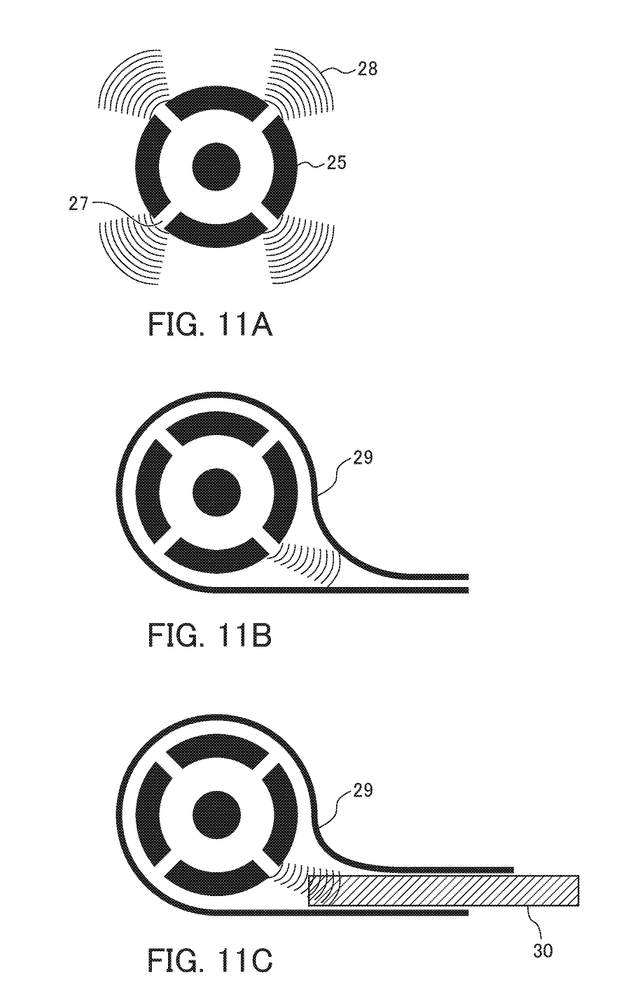

A low attenuation treatment illustrated in FIGS. 11A to 11C to be described below may be performed for the communication track 25.

The communication track 25 performs amplification for every predetermined section, and electric power that is required for the amplification is received from the DC electric power transmission line 24. The output of electric power from the DC electric power transmission line 24 is received by causing a screw to go through the coating of the DC electric power transmission line 24 and peeling off oxide coating that is a part of the outer conductor 32. The electric power reception unit 2 and the communication track 25 are connected to each other electromagnetically.

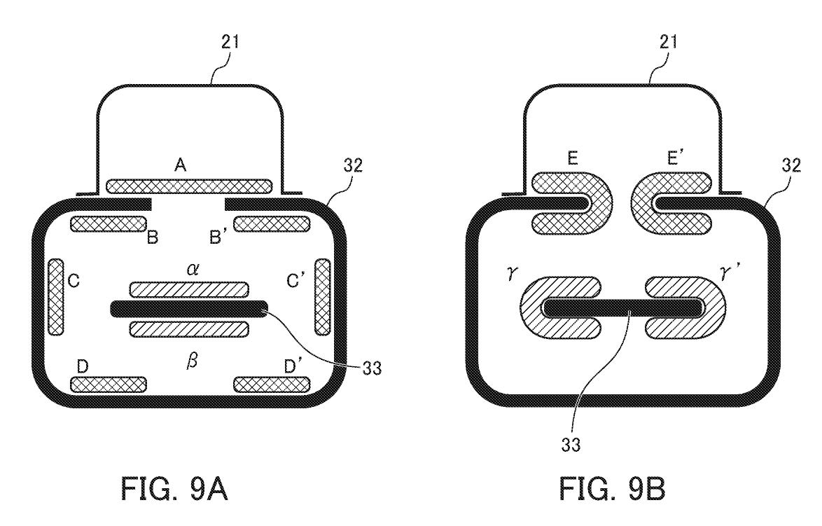

FIGS. 9A and 9B are diagrams that illustrate examples of the arrangement of electric power reception electrodes 22 for an unbalanced track. Electric power reception electrodes 22 denoted by each English character illustrate an example of a case where electric power is received from the outer conductor 32, and one set thereof is employed. Electric power reception electrodes 22 denoted by each Greek character illustrates a case where electric power is received from the inner conductor 33, and one set thereof is employed.

As illustrated in FIGS. 9A and 9B, as examples in which electric power from the outer conductor 32 is received at the outside of the outer conductor 32, there are A and a combination of E-E′. In this case, there is concern that a displacement current is discharged into a space, and accordingly, by attaching a shield cover 21, the displacement current is prevented from being discharged.

As illustrated in FIGS. 9A and 9B, as examples in which electric power from the outer conductor 32 is received inside the outer conductor 32, there are B-B′, C-C′, and D-D′. In these examples, the electric power reception electrodes are attached to the inside of the outer conductor 32 shielding the radiating electric field, and, similar to the case in which the electric power from the outer conductor 32 is received at the outside of the outer conductor 32, the electric power reception electrodes 22 are arranged symmetrically. In this way, the radiating electric fields are offset.

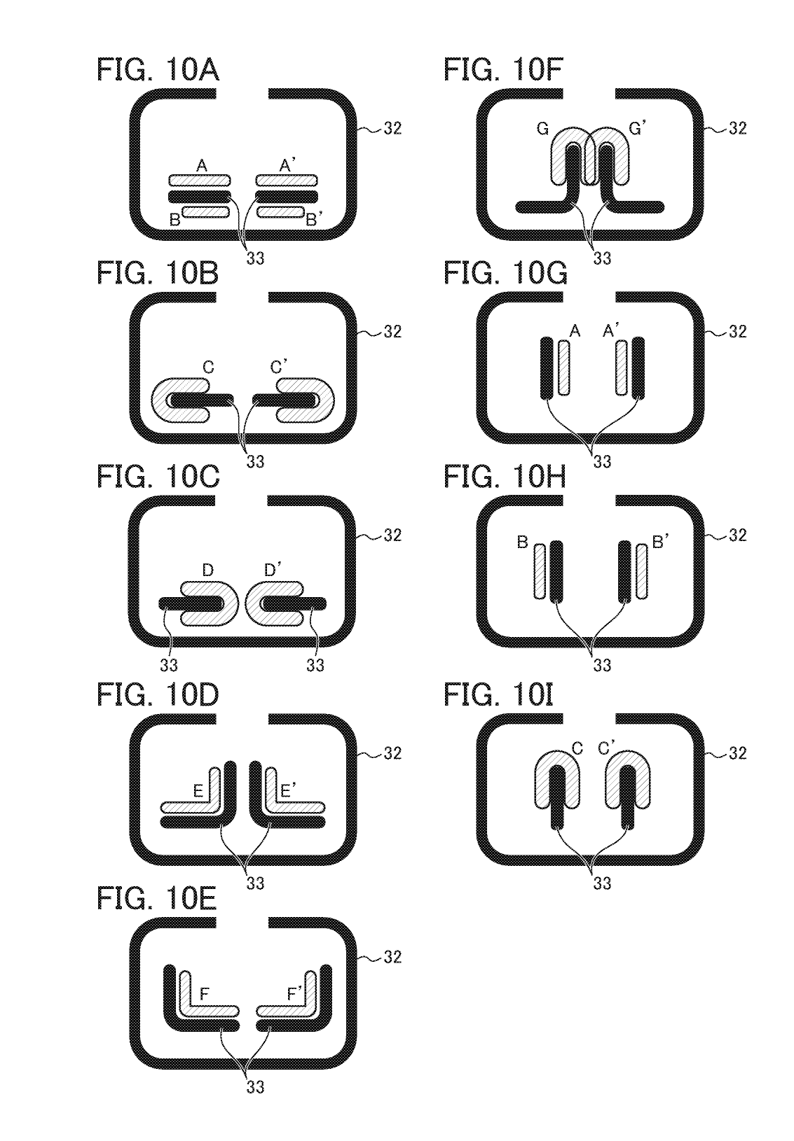

FIGS. 10A to 10I illustrate examples of the arrangement of electric power reception electrodes 22 in a balanced track. As illustrated in FIGS. 10A to 10I, as examples of combinations in which the electric power reception electrodes 22 are arranged in each of two inner conductors 33 arranged inside the outer conductor 32, there are A-A′, B-B′, C-C′, D-D′, E-E′, F-F′, G-G′, H-H′, I-I′, and J-J′. In any of the cases, by symmetrically arranging the electric power reception electrodes, radiating electric fields are offset.

FIGS. 11A to 11C are diagrams that illustrate measures for reducing attenuation of a communication signal in a communication track 25. FIG. 11A is a diagram that illustrates the communication track 25 in which no measure is taken. FIG. 11B is a diagram that illustrates a case where the communication track 25 is surrounded by a metal shield 29. FIG. 11C is a diagram that illustrates a state in which an antenna is inserted at an opening end of the metal shield 29.

As illustrated in FIG. 11A, in the communication track 25 in which no measure is taken, electromagnetic energy 28 is radiated from a slit 27, and accordingly, distance attenuation is increased. In contrast to this, as illustrated in FIG. 11B, in a case where the communication track 25 is surrounded by a shield of extremely-thin metal or the like, the radiation of electromagnetic waves is reduced, and accordingly, distance attenuation can be decreased.

In a case where an electromagnetic wave is received/transmitted from/to the communication track 25, as illustrated in FIG. 11C, there is a method in which an insertion-type antenna 30 is inserted into the end portion of the metal shield 29 to slide therethrough. By employing such a structure, the insertion-type antenna 30 can be moved in accordance with the movement of the electric power reception unit 2. In addition, in the case where the insertion-type antenna 30 is not inserted, automatically, as illustrated in FIG. 11B, the communication track 25 is returned to the state being surrounded by the metal shield 29.

By surrounding the communication track 25 with a shielding material such as the metal shield 29, electromagnetic waves do not need to be leaked outside. In this way, information leaky to a hacker or the others accompanying with the leaky of control information or the like to the outside can be prevented. At the same time, electromagnetic disturbances to the other devices can be prevented.

By shielding the communication track 25 functioning as a control track, the resistance to electromagnetic disturbances from a peripheral system can be improved. In addition, at the same time, since electromagnetic disturbances from a hacker or the others can be excluded, a system having high reliability can be built.

In a case where the electric power reception unit 2 moves, and the electric power reception electrode 22 moves on the electric power transmission electrode 21 (the contactless electric power transmission track 23), a physical gap between the electric power transmission electrode 21 and the electric power reception electrode 22 need to be maintained.

Particularly, in a case where an extruded material is used as the rail material, while there is an advantage of building a rail at a small cost, there is a disadvantage of the mechanical accuracy being bad. However, in order to build a long-distance track at a small cost, it is necessary to a rail formed using an extruded material as well. Accordingly, the electric power reception unit 2 needs a means for controlling the electrode gap or reducing friction.

As a method for controlling the electrode gap and reducing the friction, there is a method in which the electric power transmission electrode 21 and the electric power reception electrode 22 are brought into contact with each other and a method in which both are configured not to be in contact with each other.

As a method for bringing the electric power transmission electrode 21 and the electric power reception electrode 22 into contact with each other, there is a method in which the surfaces of the electrodes are coated with a material having strength and slidability. As an example of such a material, there is diamond-like carbon (DLC) or the like.

Alternatively, in order to prevent damages of the surfaces of the electrodes, the electric power transmission electrode 21 and the electric power reception electrode 22 may be caused to be in a slight contact. Alternatively, in order to reduce the friction, an ultrasonic wave may be applied to the electrode. Alternatively, in order to reduce the friction, the electrodes may be formed in a rotary body or a caterpillar shape. Alternatively, in order to control the gap between the electric power transmission electrode 21 and the electric power reception electrode 22, a piezo element may be used. In such a case, the piezo element repeats operations of detecting a contact and separating the electrodes.

As a method for causing the electric power transmission electrode 21 and the electric power reception electrode 22 to be in no contact with each other, there is a method of extremely approaching the electrodes in accordance with mechanical precision. Alternatively, in order to control the gap precisely, a piezo element may be used. In such a case, control is performed so as not to cause any contact by using a sensor.

Alternatively, for separation of the electrodes, an air film may be placed between the electric power transmission electrode 21 and the electric power reception electrode 22. For example, there are a method of blowing air between the electrodes using a pump, a method of forming an opening for taking air into the electrodes and taking air thereinto to float the electrode at the time of moving, and the like.

Alternatively, the electric power transmission electrode 21 and the electric power reception electrode 22 may be separated from each other by using a magnetic method. For example, there are a method of receiving a repulsive force using a varying magnetic field and floating the electrode, a method of arranging permanent magnets and floating the electrode, and the like.

Alternatively, the electric power transmission electrode 21 and the electric power reception electrode 22 may be floated and separated from each other by using ultrasonic floating or superconductive floating. Alternatively, a gap space may be formed to be plasma through barrier discharge to increase the conductivity such that transmission can be performed even in a wide gap.

The track structure in which the DC electric power transmission line 24 and the communication track 25 runs parallel with the contactless electric power transmission track 23, illustrated in FIG. 3, or the track structure in which the contactless electric power transmission track 23 and the DC electric power transmission line 24 are completely separated from each other, illustrated in FIG. 4 can be applied to not only the electric field coupling system (electric field coupling electric power transmission technique) but also a contactless electric power transmission track of the magnetic field coupling system.

FIG. 12 is a diagram that illustrates the case where a magnetic field coupling system are applied to an outer conductor 32 and a DC electric power transmission line 24.

As illustrated in FIG. 12, since a loop current 35 is present within a unit section 51, only when an electric power reception unit 2 is present within the unit section 51, the loop current can be caused to flow within the unit section 51. In this way, a current is not caused to flow up to an unnecessary place other than the unit section, and accordingly, a copper damage can be reduced.

The wiring of the inverter and the end portion of the loop current 35 are configured to have a structure through which an “E”-type core can pass.

The number of DC electric power transmission lines 24 illustrated in FIG. 12 is not limited to one. In other words, there may be two lines such that the contactless electric power transmission track 23 and the DC electric power transmission line 24 illustrated in FIG. 4 are completely separated from each other.

As above, while various embodiments of the present invention have been described, the present invention is not limited to the embodiments described above, and changes, alternations, and the like in a range in which the object of the present invention can be achieved belong to the present invention. In other words, as the configuration of an electric power supply system according to the present invention, the following configuration is sufficient, and various embodiments including the embodiments described above may be employed.

An electric power supply system according to the present invention is:

an electric power supply system (for example, the power supply system illustrated in FIG. 3) to which an electric field coupling electric power transmission technique is applied, the electric power supply system comprising:

an electric power transmission track (for example, the contactless electric power transmission track 23 illustrated in FIG. 3) that transmits electric power from an AC power source having a predetermined wavelength;

an electric power reception unit (for example, the electric power reception electrodes 22 illustrated in FIG. 2) that includes an electric power reception electrode (for example, the electric power reception unit 2 illustrated in FIG. 2), and moves along the electric power transmission track, wherein the electric power reception unit makes a portion of the electric power transmission track that faces the electric power reception electrode into an electric power transmission electrode, and forms junction capacitance by using the electric power transmission electrode and the electric power reception electrode, so that the electric power reception unit receives electric power from the electric power transmission track and supplies the received electric power to a load; and

a DC track (for example, the DC electric power transmission line 24 illustrated in FIG. 3) that is used for transmitting DC electric power to the electric power transmission track,

wherein the electric power transmission track includes a plurality of unit sections (for example, the unit section 51 illustrated in FIGS. 5A and 5B) which are arranged repeatedly,

wherein each of the plurality of unit sections has a length based on the predetermined wavelength and generates a standing wave from the AC power source wherein each of the plurality of the unit sections includes an inverter (for example, the inverter 34 illustrated in FIG. 3) that converts DC electric power transmitted through the DC track into AC electric power having the predetermined wavelength.

Therefore, an electric power supply system to which an electric field coupling electric power transmission technique is applied can establish a technique capable of long-distance transmission of electric power, allowing electric power to be taken out at an arbitrary position, and performing communication.

The unit section may include one or more construction modules (for example, the construction module 52 illustrated in FIG. 5A) which are to be units for construction, and the construction module may include an inductor (for example, the inductors Lm1 to Lmn illustrated in FIGS. 5A and 5B) resonating with inter-line capacitance of the electric power transmission track.

The electric power supply system may include a transformer connected to the electric power reception electrode and having a primary side winding and a secondary side winding,

wherein the electric power reception unit may be configured to satisfy or substantially satisfy Z₀=n²R/m where an impedance of the track is denoted as Z₀;

a number of electric power reception units is denoted as m;

a resistance of the load is denoted as R; and

a ratio between a number of coil turns of the primary side winding and a number of coil turns of the secondary side winding is denoted as n:1,

the electric power reception unit is configured to satisfy or substantially satisfy Z₀=n²R/m.

Therefore, maximum electric power reception efficiency can be achieved.

The electric power transmission track may have an unbalanced track structure including an outer conductor (for example, the outer conductors 32 illustrated in FIGS. 9A and 9B) having a hollow portion and an inner conductor (for example, the inner conductor 33 illustrated in FIGS. 9A and 9B) arranged in the hollow portion of the outer conductor,

wherein the outer conductor and the electric power reception electrodes forming the junction capacitance may be arranged to face each other at outside of the outer conductor, and

wherein the electric power supply system may further include a shield cover (for example, the shield cover 21 illustrated in FIGS. 9A and 9B) that covers the electric power reception electrodes.

The electric power transmission track may have an unbalanced track structure including an outer conductor (for example, the outer conductor 32 illustrated in FIGS. 9A and 9B) having a hollow portion and an inner conductor (for example, the inner conductor 33 illustrated in FIGS. 9A and 9B) arranged in the hollow portion of the outer conductor,

wherein the outer conductor and the electric power reception electrodes forming the junction capacitance may be arranged to face each other at inside of the outer conductor, and

wherein the electric power reception electrodes may be arranged to have symmetry (for example, arranged like that illustrated in FIGS. 9A and 9B) to offset radiating electric fields.

The electric power supply system may further include a communication track (for example, the communication track 25 illustrated in FIG. 3) that is constituted by a leaky coaxial track and is used for communication.

It may be configured such that the communication track is covered with a metal shield (for example, the metal shield 29 illustrated in FIGS. 11A to 11C) being closed normally and having an opening end into which an antenna is inserted,

and the antenna (for example, the insertion-type antenna 30 illustrated in FIGS. 11A to 11C) that is used for transmitting and receiving electromagnetic waves from the communication track and can move in accordance with moving of the electric power reception unit is inserted into the end portion of the metal shield.

### EXPLANATION OF REFERENCE NUMERALS

1 electric power transmission unit
2 electric power reception unit
11 and 14 parallel resonant circuit
12 and 15 transformer
16 stepdown DC/DC converter having high voltage input and low input impedance
17 moving/communicating/acting unit
18 driving wheel
19 guide wheel
20 moving electric power reception unit
21 electric power transmission electrode
22 electric power reception electrode
23 contactless electric power transmission track
24 and 41 DC electric power transmission line
25 communication track
27 slit
28 electromagnetic energy
29 metal shield
30 insertion-type antenna
32 and 82 outer conductor
33 and 83 inner conductor
34 inverter
51 unit section
52 construction module
61 outer conductor connecting part
62 inner conductor connecting part
70 coaxial line with slit
81 connector

1. An electric power supply system to which an electric field coupling electric power transmission technique is applied, the electric power supply system comprising:
an electric power transmission track that transmits electric power from an AC power source having a predetermined wavelength;
an electric power reception unit that includes an electric power reception electrode, and moves along the electric power transmission track, wherein the electric power reception unit makes a portion of the electric power transmission track that faces the electric power reception electrode into an electric power transmission electrode, and forms junction capacitance by using the electric power transmission electrode and the electric power reception electrode, so that the electric power reception unit receives electric power from the electric power transmission track and supplies the received electric power to a load; and
a DC track that is used for transmitting DC electric power to the electric power transmission track,
wherein the electric power transmission track includes a plurality of unit sections which are arranged repeatedly,
wherein each of the plurality of unit sections has a length based on the predetermined wavelength and generates a standing wave from the AC power source,
wherein each of the plurality of the unit sections includes an inverter that converts DC electric power transmitted through the DC track into AC electric power having the predetermined wavelength.

2. The electric power supply system according to claim 1,
wherein the unit section includes one or more construction modules which are to be units for construction, and
wherein the construction module includes an inductor resonating with inter-line capacitance of the electric power transmission track.

3. The electric power supply system according to claim 1, further comprising a transformer connected to the electric power reception electrode and having a primary side winding and a secondary side winding,
wherein where an impedance of the track is denoted as Z0;
a number of electric power reception units is denoted as m;
a resistance of the load is denoted as R; and
a ratio between a number of coil turns of the primary side winding and a number of coil turns of the secondary side winding is denoted as n:1,
the electric power reception unit is configured to satisfy or substantially satisfy −Z0=n2R/m.

4. The electric power supply system according to claim 1,
wherein the electric power transmission track has an unbalanced track structure including an outer conductor having a hollow portion and an inner conductor arranged in the hollow portion of the outer conductor,
wherein the outer conductor and the electric power reception electrodes forming the junction capacitance are arranged to face each other at outside of the outer conductor, and
wherein the electric power supply system further comprises a shield cover that covers the electric power reception electrodes.

5. The electric power supply system according to claim 1,
wherein the electric power transmission track has an unbalanced track structure including an outer conductor having a hollow portion and an inner conductor arranged in the hollow portion of the outer conductor,
wherein the outer conductor and the electric power reception electrodes forming the junction capacitance are arranged to face each other at inside of the outer conductor, and
wherein the electric power reception electrodes are arranged symmetrically to offset radiating electric fields.

6. The electric power supply system according to claim 1, further comprising:
a communication track that is constituted by a leaky coaxial track and is used for communication.

7. The electric power supply system according to claim 6,
wherein the communication track is covered with a metal shield, and
wherein an antenna that is used for transmitting and receiving electromagnetic waves from the communication track and can move in accordance with moving of the electric power reception unit is inserted into an end portion of the metal shield.
